(19) United States
(12) Patent Application Publication
(10) Pub. No.: US 2020/0294039 A1
(43) Pub. Date: Sep. 17, 2020

(54) RETAIL BLOCKCHAIN METHOD AND APPARATUS

(71) Applicant: THE BANK OF NOVA SCOTIA, TORONTO (CA)

(72) Inventors: MICHAEL DE LUCA, TORONTO (CA); HENRY KESISYAN, TORONTO (CA)

(21) Appl. No.: 16/608,404

(22) PCT Filed: Feb. 27, 2018
(86) PCT No.: PCT/CA2018/000041

§ 371 Date: Oct. 25, 2019

Related U.S. Application Data
(60) Provisional application No. 62/505,609, filed on May 12, 2017.
(60) Provisional application No. 62/502,553, filed on May 5, 2017.
(60) Provisional application No. 62/489,995, filed on Apr. 25, 2017.

(51) Int. Cl. G06Q 20/38; G06Q 20/40; H04L 29/06; H04L 9/32

(52) U.S. Cl. CPC G06Q 20/389; G06Q 20/40145; H04L 63/0861; H04L 2209/04; H04L 9/3236; H04L 2209/38; H04L 2209/56; H04L 9/3231

(57) ABSTRACT

There is provided an example payment processing system comprises: a plurality of nodes, each hosting an instance of a block chain; a server in communication with the nodes by way of a network; a biometric scanning device in communication with the server for acquiring user credentials based on a biometric measurement and sending the user credentials to the server; wherein the block chain contains a data structure defining a concordance between the user credentials and user accounts in the blockchain.

### FIELD

This relates to payment processing and processing of credentials in payment systems, and in particular, in systems using block chain technology.

### BACKGROUND

Blockchain technology and cryptocurrencies are becoming increasingly popular. Storing data in a blockchain may avoid the need for a central data repository, which can provide fault tolerance and protect against tampering. Moreover, blockchain technology can provide anonymity for entities participating in the blockchain. However, typical blockchain implementations are limited in that interfacing with the blockchain, e.g. to perform transactions, is complicated or inconvenient, and in that they do not provide an easy way to exchange in-chain value with real-world currency.

### SUMMARY

An example payment processing system comprises: a plurality of nodes, each hosting an instance of a block chain; a server in communication with the nodes by way of a network; a biometric scanning device in communication with the server for acquiring user credentials based on a biometric measurement and sending the user credentials to the server; wherein the block chain contains a data structure defining a concordance between the user credentials and user accounts in the blockchain.

### BRIEF DESCRIPTION OF DRAWINGS

In the figures, which depict example embodiments:

FIG. 1 is a schematic diagram of a payments system;

FIG. 2 is a schematic diagram of a blockchain data storage;

FIG. 3 is a schematic diagram of objects stored in the data storage of FIG. 2;

FIGS. 4A-4B are schematic diagrams of data objects stored in the data storage of FIG. 2;

FIG. 5 is a flow chart showing a method of registering credentials to an account in the data storage of FIG. 2;

FIG. 6 is a schematic diagram of a registration record created during the method of FIG. 5;

FIG. 7 is a flow chart showing a method of issuing credits to an account in the data storage of FIG. 2;

FIG. 8 is a schematic diagram of a transaction record created during the method of FIG. 7;

FIGS. 9A-9B are schematic diagrams showing changes to account records during the method of FIG. 7;

FIGS. 10A-10B are schematic diagrams showing changes to account records during the method of FIG. 7;

FIG. 11 is a flow chart showing a method of spending credits from an account stored in the data storage of FIG. 2;

FIG. 12 is a schematic diagram showing a transaction record created during the method of FIG. 11;

FIG. 13 is a schematic diagram showing changes to an account record during the method of FIG. 11;

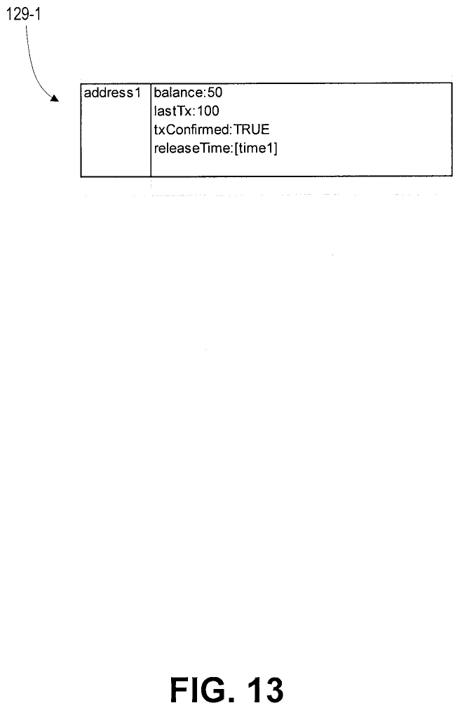

FIG. 14 is a flow chart showing a method of transferring credits between accounts stored in the data storage of FIG. 2;

FIG. 15 is a schematic diagram showing a transaction record created during the method of FIG. 14;

FIG. 16 is a schematic diagram showing changes to an account record during the method of FIG. 14; and

FIG. 17 is a schematic diagram of a software interface at a device of the payments system of FIG. 1.

### DETAILED DESCRIPTION

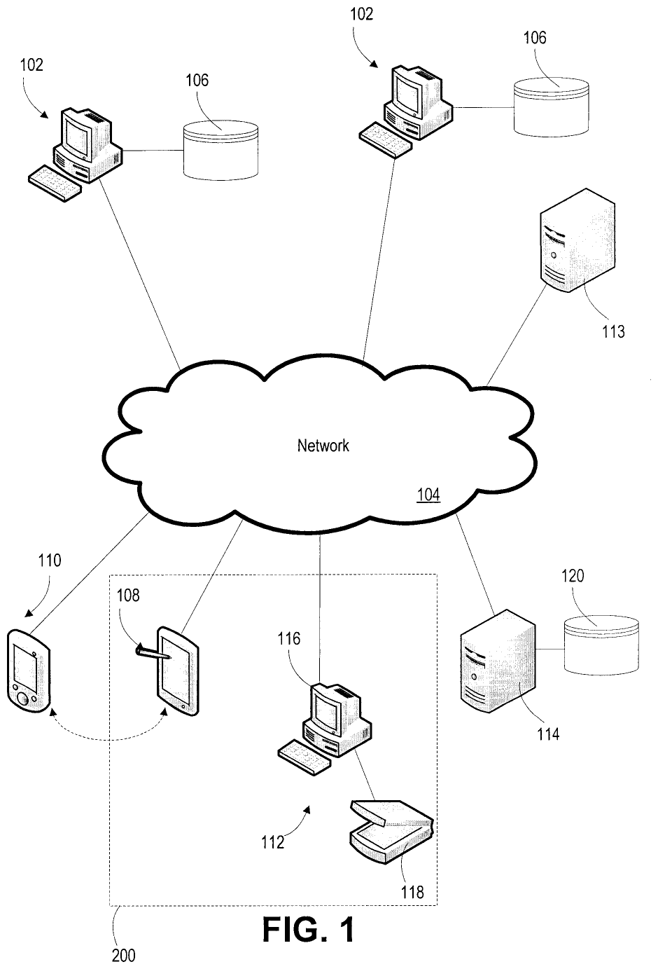

FIG. 1 depicts a payments system 100. Payments system 100 provides for processing of transactions and storage of transaction information in a decentralized data storage referred to as a blockchain. Individuals and organizations using payments system 100 may be referred to herein as users, and may include consumers, retailers, service providers, and any other businesses, individuals or entities needing to send or receive payments.

In embodiments, transactions in payment system 100 use credits which represent legal currency. Users are able to send credits to one another, and payment system 100 tracks credits held by each user. Payment system 100 further provides the ability to interface with payment processing systems that use legal currency. Thus, payment system 100 provides the ability to increment or decrement credits based on payments of currency.

The decentralized nature of the blockchain relies on its contents being accessible at each node in the system, and evaluation of state changes being computable at any node in the system. In other words, account identifiers and status information, such as balance and transaction history, can be determined at each node in the system. Thus, for privacy reasons, account identifiers may be set to obfuscate private data of the individual or entity associated with the account. Nevertheless, it may be desired to allow for convenience and ease of access. Accordingly, payment system 100 allows for easy presentation and processing of credentials to validate users.

Payments system 100 comprises a plurality of nodes 102, each of which comprises a computing device such as a PC, tablet computer, smartphone, or the like, based on Microsoft Windows, Apple OS X or iOS, Android, Linux, or other suitable operating systems.

Nodes 102 are connected by way of one or more networks 104. The networks 104 may include one or more local-area networks or wide-area networks, such as IPv4, IPv6, X.25, IPX compliant or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE networks.

Each node 102 of data storage system 100 hosts an instance of a blockchain application, namely an application for managing a decentralized data store 106, which may be blockchain-based. Each instance hosts a copy of the data store 106. Logic within the blockchain application, embedded in the data store 106 itself, or a combination thereof, maintains consistency of the copies of data store 106 and, along with instances of the application at other nodes 102, controls updating and changing of data store 106, e.g. using a consensus algorithm. Data store 106 may be referred to as a block chain in that it contains blocks of data, each block representing a state at a particular point in time. That is, the current contents are reflected in a current block. Preceding blocks, each representing a historical state at a particular point in time, are retained and, using cryptographic error-correction techniques, are used to verify the integrity of data in successive blocks.

Payments system 100 further comprises one or more point of sale devices 108, one or more client devices 110, one or more spending terminals 112, one or more web servers 113 and one or more matching servers 114.

Point of sale devices 108 may be any device suitable for receiving payments and capable of connecting to network 104. Point of sale devices may include, for example, PCs, tablet computers, smartphones, or the like, based on Microsoft Windows, Apple OS X or iOS, Android, Linux, or other suitable operating systems. Point of sale devices 108 may further include peripherals such as card readers, keypads, contactless (e.g. NFC) readers, or the like, for receiving credentials to authorize transactions using currency.

Client devices 110 may be any suitable devices capable of connecting to network 104 and directly exchanging data with point of sale devices 108. Client devices may include, PCs, tablet computers, smartphones, or the like, based on Microsoft Windows, Apple OS X or iOS, Android, Linux, or other suitable operating systems.

Spending terminals 112 are configured to communicate with point of sale devices 108 and matching server 114 by way of network 104. Communication with point of sale devices 108 may be via matching server 114. Each spending terminal includes a computing device 116 such as a PC, tablet computer or the like, and a scanning device 118. The scanning device 118 is operable under control of the computing device to acquire data for use as an identifier of an individual user. In some embodiments, the scanner 118 is a biometric scanner, and the identifier is a number, such as a random number, mapped against the biometric measurement of the user. For example, the scanner 118 may be a hand scanner configured to obtain a measurement of contours of a user's hand and generate a parametrized model of the hand and points to a value such as a random and unique number to represent the user. As described in further detail below, the resulting identifier is associated with a user's address and account values in a smart contract 123 of data store 106. In other embodiments, scanner 118 may be configured for obtaining and generating a parametrized model based on other types of biometric measurements, or based on other physical tokens such as cards or the like. Each spending terminal 112 may be co-located with a point of sale device 108. That is, the spending terminal may be located, e.g. in the same store or outlet.

Matching server 114 is configured for communication with nodes 102, point of sale devices 108, client devices 110 and spending terminal 112 by way of network 104. Matching server hosts software, referred to as an API, configured to receive requests from and exchange data with each of point of sale devices 108, client devices 110 and spending terminal 112 to send instructions to nodes 102 for registering users, authorizing transactions and making changes in data store 106. As will be described in further detail below, matching server 114 has a working storage 120 for storing data received from other devices and data generated in the course of processing requests.

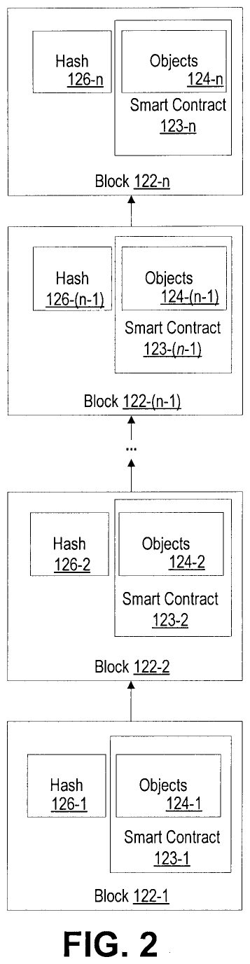

FIG. 2 depicts a schematic representation of data store 106. Data store 106 contains a sequence of blocks 122-1, 122-2 . . . 122-(n−1), 122-n (individually and collectively, blocks 122). Each respective block 122 contains one or more data structures referred to as smart contracts 123. Each smart contract 123 includes one or more sets of objects 124. Objects 124 of each block 122-1, 122-2 . . . 122-(n−1), 122-n are referred to as objects 124-1, 124-2, . . . , 124-(n−1), 124-n, respectively. States or values associated with objects 124 may be changed in each successive block. That is, authorized functions can make changes to objects 124. Changes to at least some objects 124 are committed in each block. In some embodiments, objects may be stored in each block as an initial state, i.e. the state deployed at block 1, plus a set of changes reflecting. That is, object 124-n may be stored in block 122-n in its initial state, along with changes made at each of blocks 122-2 through 122-(n−1). Object 124-n may also include a current state reflecting the cumulative effect of those changes. Other implementations are possible.

Each respective block further includes a cryptographic verification value 126. Cryptographic verification values 126 of each block 122-1, 122-2 . . . 122-(n−1), 122-n are referred to as cryptographic verification values 126-1, 126-2 . . . 126-(n−1), 126-n, respectively. The cryptographic verification value 126 is derived from the set of objects 124 of the proceeding block and the cryptographic verification value 126 of the previous block 122 using a deterministic function such as a SHA-1 hash function. That is, cryptographic verification value 126-n is derived from objects 124-(n−1) and cryptographic verification value 1126-(n−1). Each cryptographic verification value 126 therefore guards against alteration of data in preceding blocks, as any such alteration would result in a changed cryptographic verification value 126. Further cryptographic verification values (not shown) may be provided for individual smart contracts or objects within each block 122.

Data store 106 defines a configuration of a virtual machine which, when loaded at a node 102, is capable of executing instructions, e.g. scripts defined by code objects in the data store 106. In some embodiments, code objects in data store 106 are executable in an Ethereum virtual machine, as specified by the Ethereum Foundation, and data store 106 defines a state and configuration of such a virtual machine.

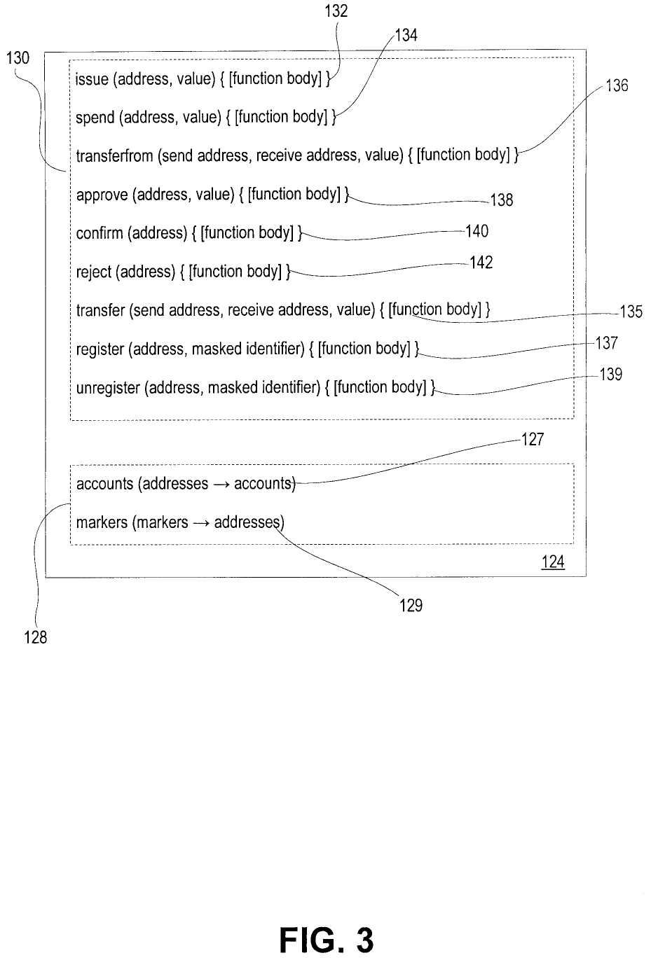

FIG. 3 provides a schematic depiction of objects 124 deployed at a block 108 of data store 106. Objects 124 include data objects 128 such as database tables, delimited arrays and the like, and code objects 130, such as functions for execution at a node 102. As noted, changes to objects 124 are tracked in each successive block in the chain.

As depicted, data objects 128 comprise addresses, account data and masked identifiers. Addresses are unique values within a defined number space or range. The values may be, for example, binary, decimal or hexadecimal values. Each unique address may be associated with and controlled by a user for identifying transaction and account data belonging to that user. Addresses may be used as part of a public-private key encryption scheme. That is, each address may be cryptographically related to a public key and a private key. Specifically, the address may be a cryptographic hash of the public key and the private key may be related to the public key by a cryptographic function.

The address and private keys may further be used for digitally signing messages using a digital signature algorithm. Specifically, a digital signature object, rsv may be generated by a cryptographic function using an input data string and the private key as inputs. That is:

sign([string], Sₖ)→rsv
Where Sₖ is the private key.

Similarly, the corresponding address may be recovered by a recover function using the input data string and the signature as inputs. That is:

recover([string], rsv)→address

The sign function above is known to each device in system 100. The recover function is known at least to matching server 114 and nodes 102.

As described below, each point of sale 108, client device 110 and spending terminal 112 has an associated address within data store 106 that is controlled by the respective devices. The corresponding private key Sₖ is stored at each respective device.

References herein to sending of signed messages by any of point of sale 108, client device 110, spending terminal 112, and matching server 114 refer to digital signing as described above. That is, for a given message, the sending device generates a signature object from the message and appends the signature object. On receipt at matching server 114 and nodes 102, the signature object and original input are used to recover the sender's address from the message.

Account data are sets of numerical or other values defining a status for each user. Account data may include, for example, an account balance, last transaction and last transaction amount values and, optionally, values for identifying allowances or limits of amounts that another user is authorized to transfer from the account. An address mapping 127, stored within a smart contract 123 at data store 106, defines a mapping of address values to corresponding accounts.

Masked identifiers are unique values associated with each user. A credential mapping 129, stored within a smart contract 123 at data store 106, defines a mapping of masked identifier values to corresponding addresses. Masked identifiers may be provided as a convenient way for users to prove ownership of an address and thus, the corresponding account. Underlying identifiers may be derived from a characteristic of a user, such as a biometric measurement, or a physical or digital token possessed by the user, such as a card or a software token value.

Code objects 130 define functions that can be executed at nodes 102 for modifying contents of data objects 128. Code objects 130 may be provided, for example, to carry out transactions of various types within data store 106. As depicted in FIG. 3, code objects 130 include an issue function 132, a spend function 134, a transfer function 135 a transfer from function 136, an approve function 138, a confirm function 140, a reject function 142, a register function 137 and an unregister function 139.

Issue function 132 increments credits in an account. The number of credits and user's address for the recipient account are received as parameters. Execution of issue function 132 increases the number of credits available for circulation in a smart contract 123 in data store 106. In an example, issue function 132 is called in response to a corresponding transaction in currency. For example, a user may enter a transaction using cash, credit card or the like, and an issue function 132 may be initiated to add credits to the user's account.

Spend function 134 deletes credits from a spending account. In other words, transfer function 134 causes credits to be decremented from the specified account. Spend function 134 receives as parameters an address identifying the owner of the account from which credits are to be decremented and a credit value to be decremented.

Transfer function 135 allows a user to send credits to a receiving account. Transfer function 135 receives as parameters addresses of the owner of the receiving account and a credit value to be transferred. On execution, credits are decremented from the function caller's account and incremented in the receiving account.

Transfer from function 136 allows a third party to initiate a transfer of credits from a sending account to a receiving account. Transfer from function 136 receives as parameters the address of the owner of the sending account and the address of the owner of the receiving account, and a credit value to be transferred. On execution, the transfer from function relies on an approval from the owner of the sending account, which can be performed prior to or after the function call, and credits are decremented from the sending account and incremented in the receiving account.

Approve function 138 is for approving a third party transfer from an account, as will be described in greater detail below. Approve function 138 receives as parameters credentials identifying a third party-initiator of a transfer, and a maximum credit value that can be transferred.

As noted, issuance of credits within a smart contract 123 of data store 106 may be premised on completion of another transaction with legal currency. That is, credits may be purchased in a transaction that occurs and is processed outside data store 106. Accordingly, credits may be issued to an account, but placed on hold pending confirmation of successful completion of the purchase transaction.

Confirm function 140 is used to provide confirmation of a purchase transaction and release a hold on issued credits. Confirm function 140 receives as parameters an address mapping to an account for which held credits are to be released.

Conversely, reject function 142 is used to indicate that a purchase transaction has failed and accordingly, to cancel issuance of credits. Reject function 142 receives as parameters an address mapping to an account for which held credits are to removed.

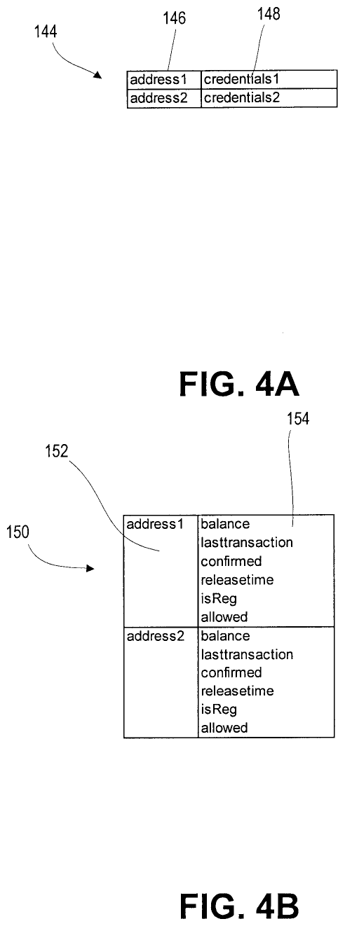

FIGS. 4A-4B are schematic depictions of data objects 130 existing within a smart contract 123 of data store 106. FIG. 4A depicts a mapping structure 144 pairing masked identifiers 146 to corresponding addresses 148. FIG. 4B depicts an account structure 150 containing address values 152 and corresponding account details 154. Upon receipt of a user identifier, the corresponding address can be determined by lookup in credential mapping structure 144. Corresponding account details may be determined by looking up the address in account structure 150.

Account details 154 stored in account structure 150 include a credit balance, a last transaction value identifying the size of the most recent issuance of credits to the account, a confirmation flag reflecting whether any transaction underlying the last credit addition (e.g. a credit card purchase) has been confirmed; a time stamp identifying a time at which the held credits of the most recent credit addition will be automatically released; and a mapping of authorized third party addresses and their respective limits or allowances to transfer from the account.

Data objects within a smart contract 123 of data store 106 further include a data structure defining permissions for invoking the functions defined in each code object. Requests to execute functions may be signed as described above. Functions may only be executed if signed by the appropriate address owner. As noted above, digital signatures resolve to an address (and thus, to a private key holder). Spend functions can only be completed if signed by an authorized spender. In the depicted example, spending terminals 112 are authorized spenders. Thus, removal of credits from a user's account requires that the user present credentials (e.g. a biometric scan) at a scanning device 118 at a spend terminal in spending terminal 112. The issue function can only be completed if signed by one of an authorized subset of users which may be referred to as issuers. In an example, at least some point of sale devices 108 are issuers. For example, point of sale devices configured to complete a currency transaction and identify an account to which credits are to be added may be issuers. Likewise, the confirm and reject functions can only be completed if signed by an issuer, to reflect the success or failure of a currency transaction upon which a credit issue is based. The transfer from function may be signed by any user, however, the requested credit transfer will succeed only if a corresponding signed approve instruction is received.

Referring again to FIG. 1, point of sale devices 108 and spending terminals 112 allow for users to be identified and instructions to be transmitted to data store 106 (and nodes 102 at which data store 106 is hosted).

As noted, spending terminal 112 includes a computing device 116 and a scanning device 118 for acquiring user data. The user data may serve directly as an identifier, or may be used to derive an identifier.

In some embodiments, scanning device 118 is a biometric scanner. Specifically, in the depicted example, scanning device 118 is a handprint scanner such as a MorphoWave scanner produced by Safran Identity and Security. Computing device 116 runs software for interfacing with scanning device 118. The software may receive any consistently reproducible unique identifier produced by the scanning device. For example, scanning device 118 may obtain a scan of a user handprint, and generate a digital model of the measurements, such as a parametrized control points representing characteristics of the hand print. Scanning device 118 may further translate the model to a unique number using an algorithm. The computing device 116 receives the unique number from the scanning device 118. A masked identifier is generated from the unique number by generating a hash value based on the unique number using a function such as a SHA hash function, and the hash value may be used as masked identifier for the user. The masked identifier may be generated by computing device 116 or by matching server 114.

Each spending terminal 112 may be located at the same physical premises 500 as a point of sale device 108. For example, a point of sale device 108 and spending terminal 112 may be located at a bank branch, retail location or the like. As will be described in further detail below, communication between each of the point of sale device 108 and the spending terminal 112 with the matching server 114 may be coordinated such that a transaction may be initiated at the point of sale device 108 and authorized using a user's credentials presented by way of spending terminal 112.

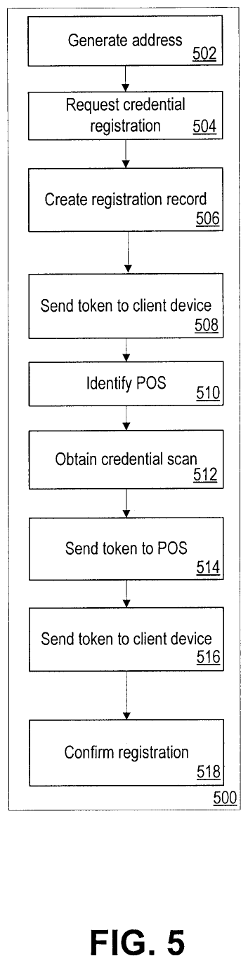

FIG. 5 depicts a process 500 of registering a masked identifier based on user credentials for association with an address (and thus, an account) in a smart contract 123 of data store 106.

At block 502, the user loads client software at the user's client device 110. The client software may be, for example, an application or a webpage, and may be loaded by installation at the client device 110 or by accessing the webpage with a browser at client device 110. The software application generates a unique private key Sₖ associated (e.g. linked by a cryptographic function) with an unused address in a smart contract 123 of data store 106. The private key Sₖ controls the address in that commands making changes to corresponding account must be signed using the private key value Sₖ. The private key value Sₖ is securely stored at the client device 110.

At block 504, the user attends at premises 200, at which a point of sale device 108 and a spending terminal 112 are located. Using client device 110, the user submits a request to register the user's address against the user's masked identifier. Specifically, client device 110 sends a request to matching server 114 by way of network 104.

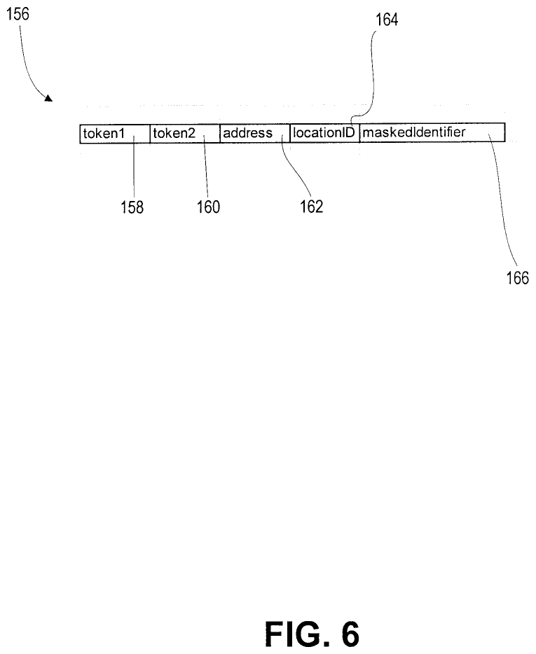

At block 506, matching server 114 receives the request and generates a registration record in working storage 120. FIG. 6 shows an example registration record 156. As depicted, working storage 120 comprises a database and registration record 156 is a record of the database. Registration record 156 includes first and second randomly-generated token values 158, 160. Token values 158, 160 are generated by matching server 114 upon receipt of a registration request from client device 110. Registration record 156 further includes an address field 162 containing the user's address, and a location ID field 164, and masked identifier field 166, both of which are described in further detail below.

At block 508, matching server 114 sends the first token value 158 to client device 110.

At block 510, the user communicates to point of sale 108 or an operator thereof that the user intends to register credentials. The request may be, for example, directly entered using an interface of the point of sale 108 or communicated to an operator of the point of sale. The first token value 158 is provided to the point of sale 108, e.g. by wireless transmission such as bluetooth or near-field communication (NFC), by scanning of symbolic indicia such as QR codes, or by verbal communication. Point of sale 108 then sends a message, e.g. an API call, to matching server 114 containing a location identifier corresponding to the physical location of point of sale 108 and the token value 158 received from the user. Matching server 114 records the location identifier in location ID field 164 of registration record 156. The location identifier may be explicitly included in the API call received from point of sale 108, or it may be retrieved from a database by matching server 114.

The value in location ID field 164 serves to identify the physical location at which the user is attempting to present credentials for registration.

At block 512, the user is instructed to enter the credentials using scanner 118. Such instructions may be provided by way of a user interface of point of sale 108, or by verbal instructions from an operator. In the depicted embodiment, scanner 118 is a MorphWave biometric hand scanner, configured to obtain a set of measurements of a human hand. Accordingly, upon instruction, the user places his or her hand into scanner 118. Scanner 118 acquires the set of measurements and resolves them to a unique identifier for the user, and passes the unique identifier to computing device 116. The computing device 116 performs a standardized data transformation, such as a cryptographic masking or hashing function on the identifier or other cryptographic function on the measurements. The standardized data transformation is a deterministic function, such that for a particular unique identifier, a corresponding unique output is produced. The resulting output is referred to as a masked identifier. Computing device 116 sends the masked identifier to matching server 114 by way of an API call.

Transformation of the identifier to a corresponding masked identifier by a function as described above obfuscates the identifier and underlying credentials from the hand (or other biometric inputs) from other users and devices of system 100. As will be apparent, an unauthorized recipient of the masked identifier would not be able to infer the identifier produced by scanning device 118 nor the characteristics of the corresponding biometric measurement, without reversing or breaking the cryptographic one-way masking function reversing the one-way function the scanning device applies to the measurements.

Matching server 114 receives the API call and determines an associated location identifier. The location identifier may be explicitly included in the API call, or it may be determined by lookup in a database. If the location identifier matches the value in location ID field 162, the received encrypted measurements are stored in the masked identifier field 166.

At block 514, matching server 114 sends a message to point of sale 108 confirming that the masked identifier has been obtained. The message includes the second randomly-generated token value 160.

At block 516, the point of sale 108 provides the second randomly-generated token value to client device 110, e.g. by wireless transmission such as bluetooth or near-field communication (NFC) or by scanning of symbolic indicia such as QR codes or by verbal communication.

Finally, at block 518, the user's client device 110 sends a message to matching server 114 by way of API call, containing the second randomly generated token 160. Receipt by the matching server 114 of the second randomly generated token 160 confirms that the acquired credentials belong to the user (and thus, to the address recorded in address field 162). Matching server 114 sends an instruction in the form of register function 137 to nodes 102 to record a mapping of the address from address field 162 and the masked identifier in masked identifier field 166 in mapping data object 129. Accounts data object 127 for the given address is also flagged as registered. Matching server may thereafter delete registration record 156 or retain it for future reference.

After an address has been mapped to a masked identifier, the user may subsequently authorize instructions by providing the credentials from which the masked identifier is derived at a spending terminal 112. Thus, in the depicted example, where credentials are derived from the handprint of a user, the user need only scan his or her hand to authorize a spend transaction.

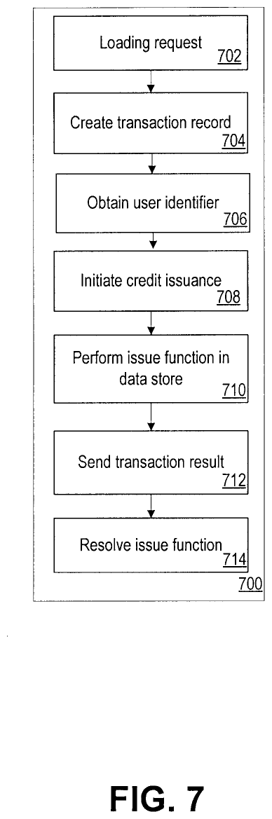

FIG. 7 shows a method 700 of loading credits to an account. Loading can be performed from a point of sale 108 at a location with a credentials terminal 112.

At block 702, a user communicates an intention to load credits into his or her account. The intention may be communicated, e.g., verbally to an operator of point of sale 108, or by direct entry into a user interface of point of sale 108. The point of sale 108 sends a request to matching server to initiate a loading of credits. The request may be sent as an API call and may include a desired number of credits to be loaded.

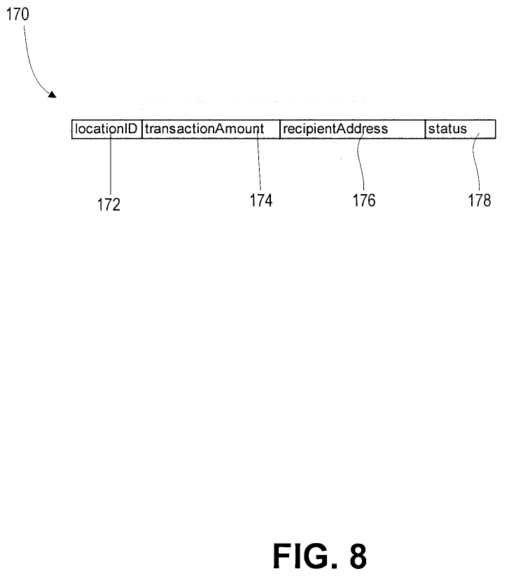

At block 704, the matching server 114 creates a transaction record 170 in working storage 120. An example transaction record 170 is shown in FIG. 8. Transaction record 170 includes a location field 172, a transaction amount field 174, a recipient address field 176 and a status field 180. The location field 172 is populated with a location ID value identifying the physical location of point of sale 108. The location ID may be explicitly provided in the API call at block 702, or may be determined by matching server 114, e.g. by lookup in a database. The transaction amount field 174 is populated with a value from the API call at block 702.

At block 706, the user presents an identifier using scanning device 118. For example, the user may be instructed, e.g. by an interface of point of sale device 108, or verbally by an operator of point of sale device 108, to present his or her hand at scanning device 118. Scanning device 118 obtains measurements of the hand and returns an identifier value derived from the measurements. A message is then sent by way of API call from computing device 116 and the user's masked identifier is obtained at matching server 114. The masked identifier is obtained by applying the standardized data transformation to the identifier received from scanning device 118. The transformation may be performed by computing device 116 prior to sending the API call, or by matching server 114 on receipt of the API call.

Matching server 114 receives the API call from computing device 116 and determines if the API call matches the previous API call received from point of sale device 108 initiating the load function. Specifically, in an example, matching server 114 checks whether the location of computing device 116 and scanning device 118 is the same as point of sale device 108 and whether time stamps associated with the API calls from point of sale device 108 and computing device 116 are within a threshold time interval. The location may be explicitly identified in the API call or determined, e.g. by lookup. If the location matches that stored in location field 172, matching server 114 retrieves the corresponding address from mapping 127. Matching server 114 sends a message to point of sale device 108 including the user's address from field 178.

Alternatively, a user may communicate his or her address to point of sale 208 using other techniques. For example, a user may communicate his or her address verbally to an operator of point of sale 208, by wireless transmission (such as NFC or bluetooth)

At block 708, point of sale 108 sends an instruction to matching server 114 for issuing credits in a smart contract 123 in data store 106. Specifically, point of sale 108 constructs a command for invoking issue function 132 within data store 106. The issue function call includes the recipient address received from the user or from matching server 114 and a value of credits to be issued. Point of sale 108 signs the issue function call with its private key Sₖ and sends an API call to matching server 114, including the signed issue function call. Matching server 114 forwards the signed issue function call to nodes 102 for execution in data store 106.

Sending of the issue instruction by point of sale 108 may be in response to performance of a transaction at point of sale 108. For example, after requesting loading of a certain number of credits, a user may complete a transaction in currency, e.g. using a credit card, which may prompt the point of sale 108 to form an API call including an issue instruction.

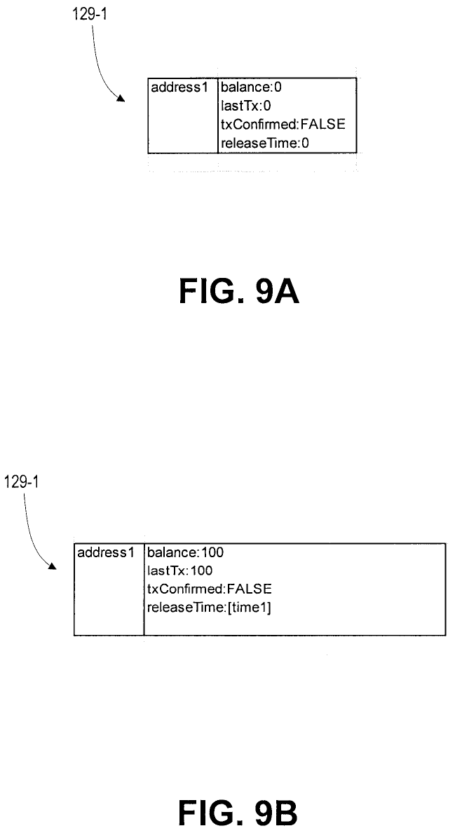

FIGS. 9A-9B show values in an account record 129-1 of accounts data object 129 before and after an issue command for adding 100 credits to the account. For simplicity, values in account record prior to the issue command are shown as zero. After the issue command, balance is incremented by 100. A last transaction (lastTx) value is set to the value of the most recent transaction in the account, namely, 100. A confirmation flag (txConfirmed) is set to FALSE, indicating that the most recent transaction has not been confirmed. A release time flag (releaseTime) is set to the time of the issue command, plus a predetermined hold duration. As long as the confirmation flag is FALSE and the release time is in the future, the balance available to be spent is reduced by the last transaction amount. Thus, in the depicted example, zero credits can be spent until the time is past time1 or the confirmation flag is set to TRUE.

Referring to FIG. 7, at block 712, the point of sale 108 receives a result of the currency transaction upon which the credit issuance was based. For example, a credit card transaction is successfully completed or is declined. Point of sale 108 constructs a command to call either the confirm function 140 or the reject function 142 within data store 106. Confirm function 140 is called if the underlying transaction was successfully completed. Reject function 142 is called if the underlying transaction failed. The function call includes the recipient address received from the user or from the matching server 114 at block 706. Point of sale 108 signs the command and sends the signed command to matching server 114 by way of an API call. Matching server 114 forwards the signed command to nodes 102 for execution in data store 106. Alternatively, the point of sale 108 can send the signed confirm or reject function directly to nodes 102.

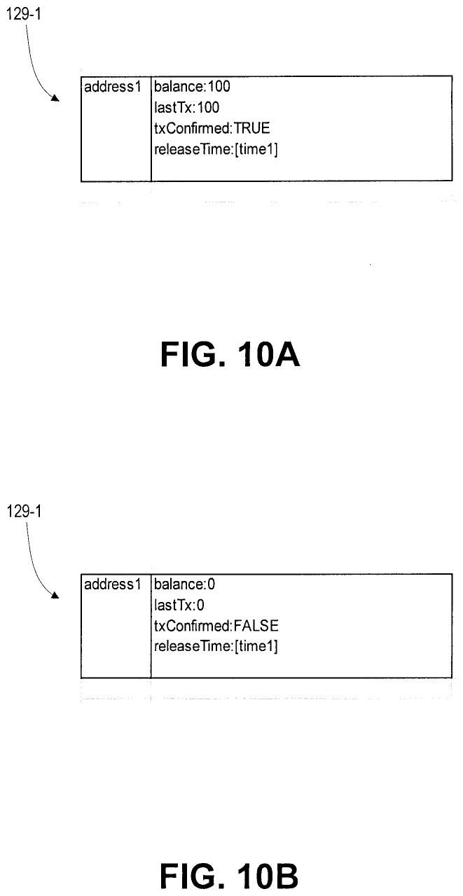

Confirm function 140 sets the confirmation flag of account record 129-1 to TRUE, as shown in FIG. 10A. As shown in FIG. 10B, reject function 142 decrements the balance of account record 129-1 by the last transaction amount, namely, 100 credits in the depicted example. Reject function 142 then sets the last transaction amount to zero.

Other methods of loading credits may be provided. For example, a user may access a web page and purchase credits via online banking or credit transaction. In the course of such a transaction, the user's address may be provided from storage on the user's client device 110.

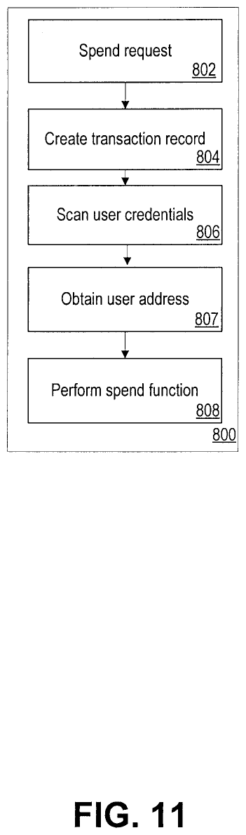

FIG. 11 depicts a method 800 of spending credits from an account in data store 106.

At block 802, a user attends at a location with a point of sale 108 and a spending terminal with a scanning device 118 and computing device 116. The user initiates a transaction, e.g. by attempting to purchase merchandise at the point of sale 108.

Point of sale 108 sends a message to matching server 114, for example, by way of an API call, including an instruction to initiate a spending transaction.

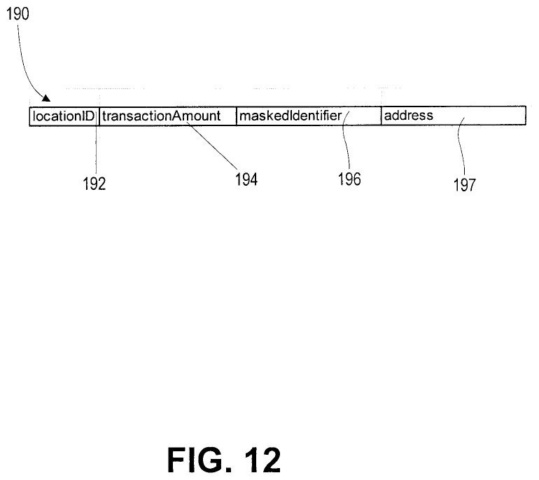

At block 804, matching server 114 creates a spend transaction record 190. An example record 190 is shown in FIG. 12. Record 190 has a location field 192, a transaction amount field 194, a masked identifier field 196, and an address field 197. Location field 192 is populated with a value identifying the physical location of point of sale 108. The location value may be explicitly included with the API call or determined, e.g. by lookup. The transaction value field is populated with a value included with the API call. For example, if an individual makes a purchase for 30 credits, the API call includes a value of 30.

At block 806, the user is instructed to present his or her credentials to credential scanner 118. Upon scanning their credentials, scanner 118 sends the unique identifier, as previously described, to computing device 116. Computing device 116 masks the identifier via the standardized cryptographic hashing function, and sends the masked identifier to matching server 114, by way of an API, along with a location identifier. Alternatively, the unmasked unique identifier may be sent to matching server 114 and masking may be done at the server 114.

At block 807, matching server 114 checks if the location ID matches than in spend transaction record 190, and if so, retrieves the address corresponding to the user's masked identifier from mapping 127. Matching server 114 then returns the address to computing device 116, along with the transaction value received from point of sale device 108.

At block 808, computing device 116 of spending terminal 112 forms a command for invoking spend function 134 (FIG. 3) within data store 106. Specifically, the command includes the address received from matching server 114, and the credit value to be spent. Computing device 116 signs the command with its private key Sₖ. and sends the signed command to matching server 114. Matching server 114 forwards the signed command to nodes 102 for execution in a smart contract 123 of data store 106. Execution of the spend function results in decrementing the balance of the account associated with the credentials in the signed command, by the amount specified. Alternatively, the computing device 116 can send the signed spend function call directly to nodes 102.

In some circumstances, it may be desired to transfer, rather than decrement credits. For example, if multiple vendors participate in system 100, it may be desired to transfer credits from a user account to a vendor's account.

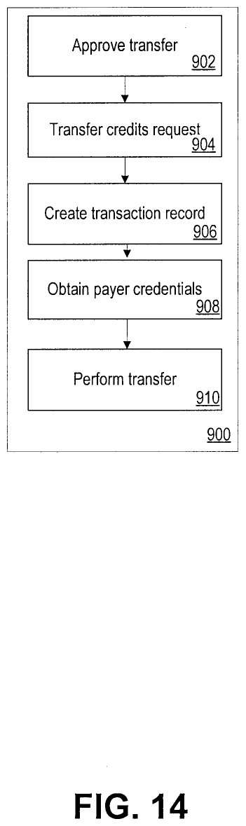

FIG. 14 depicts an example method 900 for such transactions.

At block 902, a user initiates a pre-approval for a particular point of sale device 108 to execute transfers of credits on the user's behalf. The approval has a defined limit, i.e. an aggregate value of transfers that are pre-approved. The approval value is transmitted to matching server 114, along with the address of the point of sale device 108.

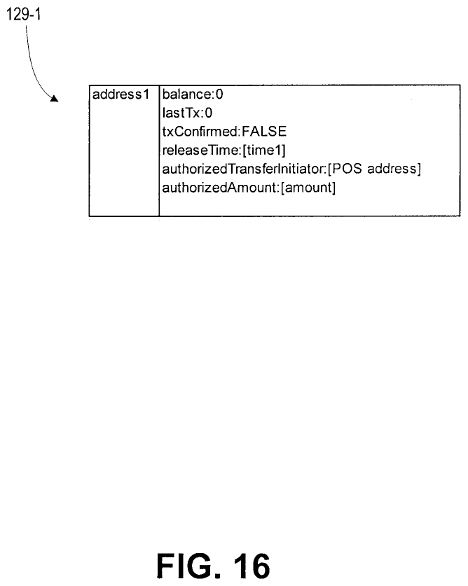

The user is prompted to present credentials using scanning device 118. The prompt may be received verbally from an operator of point of sale 108 or displayed on a user interface of point of sale 108. The user scans his or her hand at scanning device 118. Scanning device 118 acquires measurements of the user's handprint and provides a unique identifier to computing device 116, which applies a data transformation such as a hash function to convert the identifier to a masked identifier. Computing device 116 then sends the masked identifier to matching server 114, which looks up the corresponding address in mapping 127. Matching server 114 then returns the point of sale address, the user address and the approval value to computing device 116, which generates a signed approve command and sends the signed command to nodes 102 via matching server 114 or directly to nodes 102. The approve command causes the address of the point of sale device 108 and the authorized amount to be logged in the user's account record 129-1 (FIG. 16).

At block 904, a credit transfer is prompted, for example, by a user purchasing goods or services from the operator of the point of sale. The purchaser may present his or her address to the point of sale or point of sale operator, e.g. by wireless transmission from client device 110 such as bluetooth or near-field communication (NFC) or by scanning of symbolic indicia such as QR codes. Point of sale 108 sends a message to matching server 114 by way of an API call, indicating that a transfer of credits is to be initiated. The API call includes the credit value to be transferred and the address of the sender.

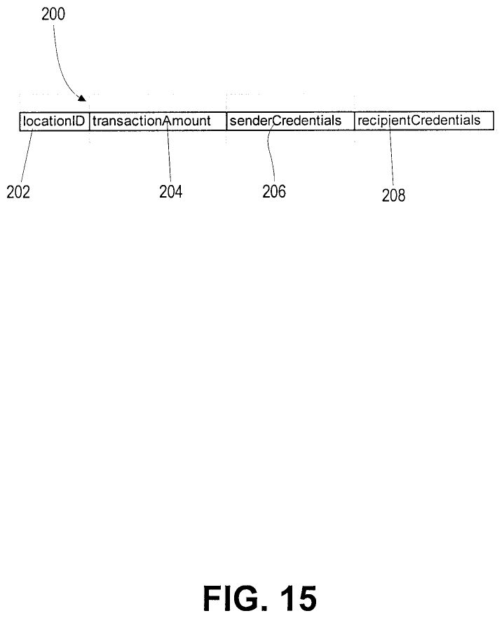

At block 906, matching server 114 creates a transaction record 200. An example record 200 is shown in FIG. 15. Record 200 has a location field 202, a transaction amount field 204, a sender address field 206 (i.e. the address of the user sending credits) and a recipient address field 208 (i.e. the address of the user receiving credits). Location field 202 is populated with a value identifying the physical location of point of sale 108. The location value may be explicitly included with the API call or determined, e.g. by lookup. The transaction value field is populated with a value included with the API call.

At block 908, the user is instructed to scan his or her credentials using scanning station 118. The user's masked identifier is obtained and matching server 114 performs a lookup of the corresponding address in mapping 127. Matching server 114 returns the address to point of sale 108.

At block 910, point of sale forms a command for causing execution of a transfer from function 136 (FIG. 3). Specifically, the command includes an address of a sender and recipient of the transfer and a credit amount to be transferred. Point of sale 108 signs the command using its private key and sends the signed command to matching server 114. Matching server forwards the signed command to nodes 102 for execution in data store 106. Nodes 102 check the digital signature of the command against the value logged in the sender's account record 129-1 and, if the digital signature matches the logged value, the sender's account balance is decremented accordingly and the recipient's account balance is incremented accordingly. The pre-authorized transfer amount logged in the user's account 129-1 is also decremented.

In some circumstances, transfers may be effected between two users, rather than from a user to a third party (or third account) by way of a point of sale device 108. In such circumstances, the transfer function 135 may be used. The transfer function 135 must be initiated from and signed by the sender of the transfer. Accordingly, to perform a transfer, a user obtains the address of a recipient. The address may be obtained verbally, by wireless transmission, scanning of indicia such as a QR code, or other suitable modes of communication.

In the above-described embodiments, control over data and functions within data store 106 is decentralized, with some functions limited to respective subsets of participants. That is, no single participant or component has full control over all functions. Rather, a first subset of users, namely point of sale devices 108 are issuers and can sign commands to invoke issue function 132. A second subset of users, namely, computing devices 116 of spending terminals 112 are spenders and can sign commands to invoke spend function 134 and approve function 138. A third subset, namely, matching server 114 has control over registration of masked identifiers and can sign commands associated with registration and unregistration. Thus, no central authority is required and any one component of system 100 has limited ability to alter contents of data store 106.

Modifications are possible. For example, matching server 114 may be given greater control over smart contract 123 in data store 106. In particular, matching server 114 could be authorized to sign additional commands such as spend or approve commands, register or unregister commands. In such an example, commands for execution in a smart contract 123 of data store 106 could originate from matching server 114 rather than being generated and signed at other components and relayed to nodes 102 by way of matching server 114. This may reduce the number of messages exchanged between components of system 100, but would increase vulnerability associated with matching server 114 being compromised.

In some embodiments, matching server 114 may be omitted, and each of point of sale devices 108, client devices 110 and spending terminals 112 could instead communicate directly with nodes 102. However, such an arrangement would impose additional computational load and network traffic on of point of sale devices 108, client devices 110 and spending terminals 112.

As described above, credentials terminals include biometric scanners for measuring the handprint of a user and converting the resulting measurements into unique identifiers. In other examples, different types of biometric scanners may be used, such as fingerprint scanners, eye (iris) scanners, voice analyzers, and the like. In still other examples, credentials may be based on non-biometric techniques. For example, credentials may be derived from secret token values at users' mobile devices; from cards such as credit or identity cards; from near-field communication devices, or the like. In some examples, one or more biometric or non-biometric techniques may be used in combination. For example, smart contract 123 in data store 106 may store additional mapping data structures relating multiple sets of masked identifiers to addresses.

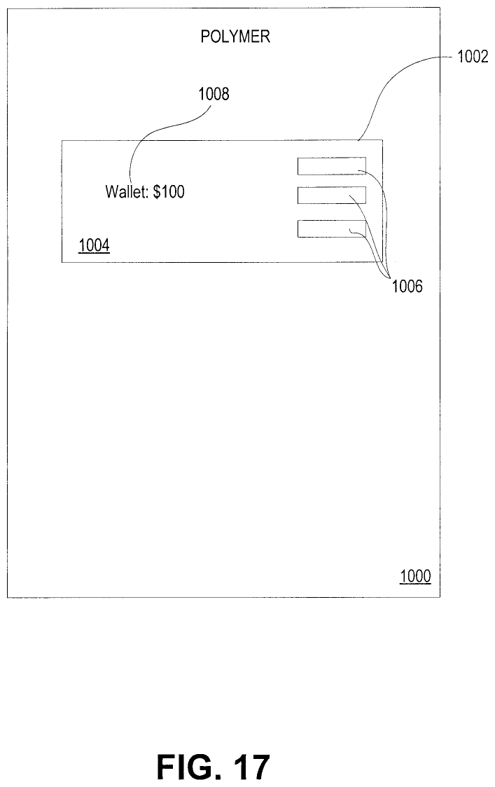

FIG. 17 shows a schematic diagram of a software interface at a client device 110. The software interface includes a webpage 1000, rendered in an internet browser application such as Mozilla Firefox, Google Chrome or the like.

Content of webpage 1000 is hosted at web server 113 (FIG. 1) and server to client device 110 by way of network 104. Webpage 1000 is referred to herein as a parent page and is interpreted and rendered by the web browser. Webpage 1000 may have access to resources at client device 110, such as files, camera, processors or graphics processors, by way of the browser and application programming interfaces (APIs) provided to the browser.

Webpage 1000 defines one or more frames 1002. Frames 1002 are discrete environments in which web content and scripts separate from webpage 1000 may be hosted and executed. That is, webpage 1000 is hosted in a location at web server 113 (FIG. 1). Each frame 1002 is a container provided by webpage 1000 for rendering content at a different location at webserver 113 or at a different web server. The content rendered within each frame 102 is itself a webpage which could otherwise be directly interpreted and rendered by a browser. In an embodiment, frame 1002 is an HTML iframe element.

In addition to standard web page functionality, each web page within a frame 1002 can communicate with the parent web page 1000. However, scripts, memory and storage are not shared between parent web page 1000 and web pages within frames 1002. Each frame 1002 is thus said to be sandboxed.

In the depicted example, frame 1002 contains a webpage 1004, referred to as a child webpage. Webpage 1004 is designed be an interface with one or more smart contracts 123 within data store 106, e.g., to provide the user of client device 110 with access to data 1008 and functions from smart contracts 123 within data store 106. Webpage 1004 further provides one or more controls 1006 for interacting with data store 106. Controls 1006 may include an element for querying data from a smart contract 123 within data store 106 or sending signed instructions to data store 106.

As will be apparent, signing instructions requires access to the private key Sₖ at client device 110. However, the private key Sₖ is sensitive in that they can be used to perform and authorize transactions in data store 106. Accordingly, protecting against unauthorized access is desirable.

Rather than providing frame 1002 and webpage 1004 with direct access to data such as the private key Sₖ at client device 110, webpage 1000 provides functions which can be invoked by webpage 1004 to perform actions such as signing commands or communicating with nodes 102.

For example, webpage 1000 may provide a function, sign(data), which, when invoked by webpage 1004, causes webpage 1000 to retrieve the private key Sₖ and cryptographically sign data passed from webpage 1004 to webpage 1000. The signed data may be passed back to webpage 1004 for sending to data store 106. Alternatively, webpage 1000 may simply send the signed data to nodes 102 for processing in data store 106.

Similarly, webpage 1000 may provide additional functions, such as displaying or scanning QR codes and maintaining an address book. Webpage 1004 may invoke a QR code display function which causes webpage 1000 to generate and display a QR code based on data that is passed as an argument from webpage 1004 to webpage 1000. Likewise, webpage 1004 may invoke a QR code scanning function to cause webpage 1000 to use the client device's camera to scan and process a QR code and return the encoded data to webpage 1004.

Other functions may also be handled in this manner.

According to the above approach, webpage 1004 hosted in frame 1002 may be able to utilize functions which rely on sensitive data, but the sensitive data may be hidden from the webpage 1004.

Webpage 1004 may be selected from a repository of content, which may be public. The repository may contain numerous different webpages written as interfaces to different smart contracts 123 or other objects within data store 106, providing differing functionality, e.g. showing different data. In some embodiments, the repository may be public, and may host content written by independent developers. Hiding of sensitive data from child webpages within frames 1002 may provide protection for users against malicious content. Accordingly, a wide variety pages, presenting a wide variety of interfaces to data store 106 may be developed and published, and users may avail themselves of such content without unduly exposing sensitive data to unauthorized access.

Although the above example is described with reference to a client device 110, the same technique may be used to provide a user interface at a point of sale 108 or at a spending terminal 112.

The embodiments described herein are examples only. Modifications to the detailed examples are possible, as will be apparent to skilled persons. Therefore, the invention is defined by the claims.

1. A payment processing system, comprising:
a plurality of nodes, each hosting an instance of a block chain;
a server in communication with said nodes by way of a network;
a biometric scanning device in communication with said server for acquiring user credentials based on a biometric measurement and sending said user credentials to said server;
wherein said block chain contains a data structure defining a concordance between said user credentials and user accounts in said blockchain.

2. The payment processing system of claim 1, wherein said user credentials comprise a unique value derived from said biometric measurement using a masking algorithm.

3. The payment processing system of claim 2, wherein said masking algorithm comprises a hash function.

4. The payment processing system of claim 3, wherein said masking algorithm comprises a function for deriving a unique value from said biometric measurement and a hash function for generating a hash of said unique value.

5. The payment processing system of claim 1, wherein said data structure comprises a first mapping of said user credentials to user accounts, and a second mapping of user accounts to unique identifiers within said blockchain.

6. The payment processing system of claim 1, wherein said blockchain comprises computer-readable code defining a function for incrementing a value associated with a user account in said blockchain.

7. The payment processing system of claim 1, wherein said blockchain comprises computer-readable code defining a function for transferring a value between user accounts in said blockchain.

8. The payment processing system of claim 1, wherein said blockchain comprises computer-readable code defining a first function for incrementing a value associated with a user account in said blockchain and a second function for transferring a value between user accounts in said blockchain, and wherein a first group of users has permissions for invoking said first function and a second group of users has permissions for invoking said second function.

9. The payment processing system of claim 1, wherein said biometrics scanning device forms part of a spending terminal comprising a computing device in communication with said server by way of said network.

10. The payment processing system of claim 1, wherein said biometrics scanning device comprises a hand scanner.

11. A method of electronic payment processing, comprising, at a server:
receiving a transaction request from a point of sale device by way of a network;
receiving user credentials from a biometric scanning device by way of a network, the user credentials comprising a unique value derived from a biometric measurement;
obtaining a user account identifier corresponding to said user credentials from a mapping data structure;
sending a transaction instruction over said network to a node hosting an instance of a block chain, the transaction instruction for changing a value associated with a user account in said block chain.

12. The method of electronic payment processing of claim 11, wherein said unique value is derived from said biometric measurement using a masking algorithm.

13. The method of electronic payment processing of claim 12, wherein said masking algorithm comprises a hash function.

14. The method of electronic payment processing of claim 13, wherein said masking algorithm comprises applying a hash function to a value derived from said biometric measurement.

15. The method of electronic payment processing of claim 1, wherein said biometric measurement is a hand scan.

16. The method of electronic payment processing of claim 1, wherein said obtaining a user account identifier comprises reading a data structure mapping of said user credentials to user accounts, and mapping said user accounts to unique identifiers within said blockchain.

17. The method of electronic payment processing of claim 1, wherein said transaction instruction comprises instructions invoking a function stored within said blockchain and defining a function for incrementing a value associated with a user account in said blockchain.

18. The method of electronic payment processing of claim 1, wherein said transaction instruction comprises instructions invoking a function stored within said blockchain and defining a function for transferring a value between user accounts in said blockchain.

19. The method of electronic payment processing of claim 1, wherein said blockchain comprises computer-readable code defining a first function for incrementing a value associated with a user account in said blockchain and a second function for transferring a value between user accounts in said blockchain, and further comprising verifying a user as belonging to a first group with permission to invoke said first function or a second group with permission to invoke said second function.
